(19) United States
(12) Patent Application Publication
(10) Pub. No.: US 2018/0334074 A1
(43) Pub. Date: Nov. 22, 2018

(54) TRAILER CONVERSION METHOD

(71) Applicant: James E. Jeffers, Lyman, SC (US)

(72) Inventor: James E. Jeffers, Lyman, SC (US)

(21) Appl. No.: 15/984,475

(22) Filed: May 21, 2018

Related U.S. Application Data
(60) Provisional application No. 62/508,909, filed on May 19, 2017.

(51) Int. Cl. B60P 3/10

(52) U.S. Cl. CPC B60P 3/105; B60P 3/1066

(57) ABSTRACT

A boat trailer converter. The boat trailer converter includes a trailer cage. The trailer cage includes a base and sidewalls extending vertically from the base. The trailer cage is mounted onto a boat trailer to convert the boat trailer into an all-purpose trailer.

### CROSS-REFERENCE TO RELATED APPLICATION

This application claims the benefit of priority of U.S. provisional application No. 62/508,909, filed May 19, 2017, the contents of which are herein incorporated by reference.

### BACKGROUND OF THE INVENTION

The present invention relates to trailers and, more particularly, to a conversion cage that converts a boat trailer into an all-purpose trailer.

A boat trailer is a trailer designed to launch, retrieve, carry and sometimes store boats. Roll-on, also known as a “Roller style trailer”, uses rubber and/or polyurethane rollers for ease of launching and loading a boat. A glide-path, also known as a “Float-on” style trailer allows the boat to float onto the trailer; after the trailer has been partially submerged (usually ¾ of the trailer). Currently, boat trailers can only be used to transport or store boats. When a boat is not in use, the boat trailer cannot currently be used for anything else.

As can be seen, there is a need for a conversion cage that converts a boat trailer into an all-purpose trailer.

### SUMMARY OF THE INVENTION

In one aspect of the present invention, a method of converting a boat trailer to an all-purpose trailer comprises steps of: providing a trailer cage comprising a base and sidewalls extending vertically from the base; providing a boat trailer comprising a tongue having a trailer coupler, a winch, a trailer frame configured to support a boat thereon, an axle, and wheels coupled to the axle; attaching a hook of the winch to the trailer cage; and pulling the trailer cage onto the trailer frame via the winch.

These and other features, aspects and advantages of the present invention will become better understood with reference to the following drawings, description and claims.

### BRIEF DESCRIPTION OF THE DRAWINGS

FIG. 1 is a side elevation view of an embodiment of the present invention in use;

FIG. 2 is a side elevation view of an embodiment of the present invention illustrating a cage being loaded onto a boat trailer;

FIG. 3 is a perspective view of an embodiment of the present invention; and

FIG. 4 is a detail cross-sectional view indicated by line 4-4 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

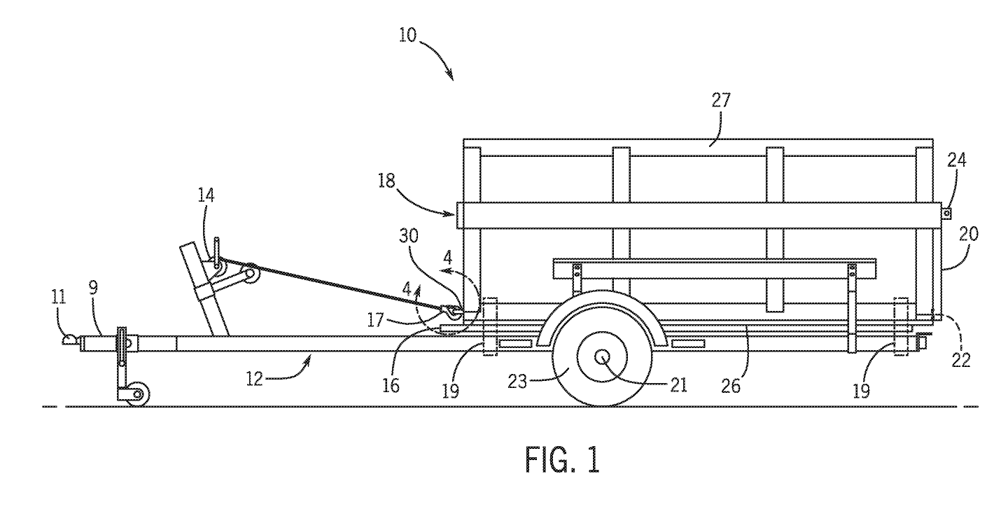

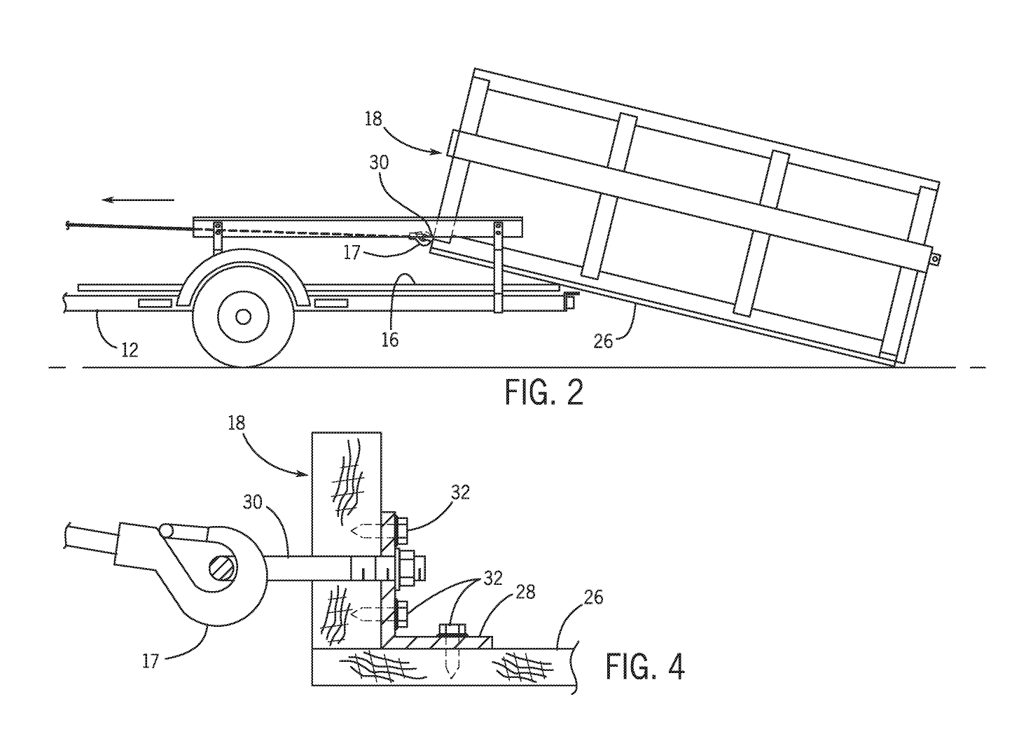

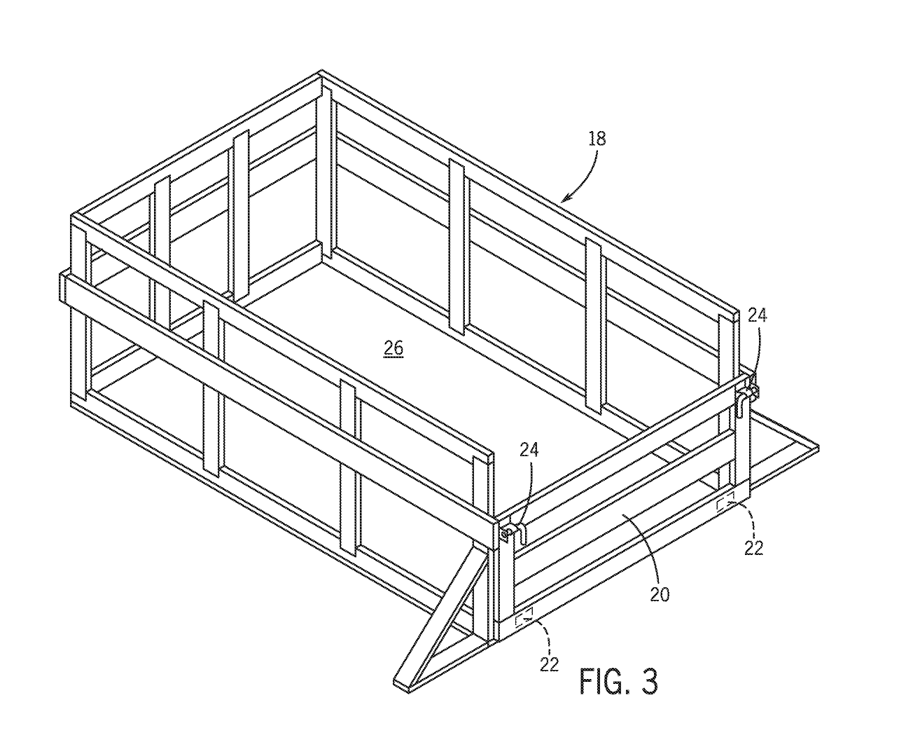

Referring to FIGS. 1 through 4, the present invention includes a boat trailer converter 10. The boat trailer converter 10 includes a trailer cage 18. The trailer cage 18 includes a base 26 and sidewalls 27 extending vertically from the base 26. The trailer cage 18 is mounted onto a boat trailer 12 to convert the boat trailer 12 into an all-purpose trailer.

As mentioned above, the trailer cage 18 includes a base 26 and sidewalls 27 vertically extending from the base 26. The sidewalls 27 may include vertical members coupled to horizontal cross members, forming a barrier around a periphery of the base 26. In certain embodiments, one of the sidewalls 27 is a tail gate door 20. In such embodiments, the tail gate door 20 is attached to the base 26 by hinges 22, and thereby may pivot up to 90 degrees relative to the base 26. Locks 24 may secure the tail gate door 27 in a closed position. In certain embodiments, casters may be secured to the bottom surface at the corners of the base 26. Further, a tarp may be used to cover the trailer cage 18 while in use.

As mentioned above, the trailer cage 18 is mounted to a boat trailer 12. The boat trailer 12 includes a tongue 9 having a trailer coupler 11. A winch 14 protrudes vertically from the tongue 9. The winch 14 may be a manual winch with a crank or an automated winch with a motor and power source. The boat trailer 12 further includes a trailer frame 16 configured to support a boat thereon. An axle 21 is coupled to the trailer frame 16. A pair of wheels 23 are rotatably coupled to the axle 21.

The trailer cage 18 is pulled onto the trailer frame 16 by the winch 14. In certain embodiments, a hook 30 protrudes from the sidewall 27 of the trailer cage 18. The winch 14 includes a hook 17 secured to a cable that is wrapped around a spool. The hook 17 of the winch 14 releasably secures to the trailer cage 18 by hooking onto the hook 30 of the trailer cage 18. The winch 14 is then either turned on or cranked to pull the trailer cage 18 onto the trailer frame 16, converting the boat trailer 12 into an all-purpose trailer.

The hook 30 of the trailer cage 18 is fastened to the sidewall 27 of the trailer cage 18. For example, an angle bracket 28 may be fastened to the base 26 and a front sidewall 27 by a plurality of bolts or screws 32. The hook 30 may be a U-bolt. Ends of the U-bolt are fastened to the angle bracket 28 by washers and nuts. The remainder of the U-bolt runs through openings of the front sidewall 27 and protrudes from an outer surface of the trailer cage 18. The hook 17 of the winch 14 easily slides onto the U-bolt, releasably connecting the trailer cage 18 to the winch 14.

The present invention may further include straps 19 to secure the trailer cage 18 to the trailer frame 16. In such embodiments, a plurality of straps 19 may wrap around the trailer cage 18 and the trailer frame 16 and the ends of the straps 19 are secured to one another. The present invention may utilize at least four straps, one securing each corner of the trailer cage 18 to the trailer frame 16. The straps 19 prevent the trailer cage 18 from detaching while the trailer cage 18 is in use.

A method of converting a boat trailer 12 to an all-purpose trailer may include the following steps: providing the trailer cage 18 described above; providing the boat trailer 12 described above; unwinding the cable of the winch 17; attaching the hook 17 of the winch 14 to the hook 30 of the trailer cage 18; winding the cable of the winch 17 back on the spool, thereby pulling the trailer cage 18 onto the trailer frame 16; and wrapping straps 19 around the trailer frame 16 and the trailer cage 18, thereby securing the trailer cage 18 to the trailer frame 16.

It should be understood, of course, that the foregoing relates to exemplary embodiments of the invention and that modifications may be made without departing from the spirit and scope of the invention as set forth in the following claims.

What is claimed is:

1. A method of converting a boat trailer to an all-purpose trailer comprising steps of:
providing a trailer cage comprising a base and sidewalls extending vertically from the base;
providing a boat trailer comprising a tongue having a trailer coupler, a winch, a trailer frame configured to support a boat thereon, an axle, and wheels coupled to the axle;
attaching a hook of the winch to the trailer cage; and
pulling the trailer cage onto the trailer frame via the winch.

2. The method of claim 1, further comprising a step of:
wrapping straps around the trailer frame and the trailer cage, thereby securing the trailer cage to the trailer frame.

3. The method of claim 1, wherein the trailer cage further comprises a hook extending from an outer surface.

4. The method of claim 3, wherein the step of attaching the hook of the winch to the trailer cage comprises a step of attaching the hook of the winch to the hook of the trailer cage.

5. The method of claim 3, wherein the hook of the trailer cage is a U-bolt.

6. The method of claim 1, wherein the sidewalls comprise vertical members and cross members.

7. The method of claim 1, wherein one of the sidewalls is a tail gate door attached to the base by a hinge.

8. The method of claim 1, wherein the tail gate door further comprises a lock configured to lock the tail gate door in a closed position.
